(19) United States
(12) Patent Application Publication
(10) Pub. No.: US 2015/0081986 A1
(43) Pub. Date: Mar. 19, 2015

(54) MODIFYING NON-TRANSACTIONAL RESOURCES USING A TRANSACTIONAL MEMORY SYSTEM

(71) Applicant: Brocade Communications Systems, Inc., San Jose, CA (US)

(72) Inventors: Bill Ying Chin, San Jose, CA (US); Poongovan Ponnavaikko, Santa Clara, CA (US); Babu Neelam, Santa Clara, CA (US)

(21) Appl. No.: 14/329,767

(22) Filed: Jul. 11, 2014

Related U.S. Application Data
(60) Provisional application No. 61/845,934, filed on Jul. 12, 2013.
(60) Provisional application No. 61/864,371, filed on Aug. 9, 2013.

(51) Int. Cl. G06F 9/46; G06F 12/02

(52) U.S. Cl. CPC G06F 9/467; G06F 12/0284; G06F 2212/1041
USPC 711/154

(57) ABSTRACT

Techniques are provided for reliable and efficient access to non-transactional resources using transactional memory. In certain aspects, a device may include memory and one or more processing entities, configurable to execute a first transaction comprising one or more write operations to a first memory address, and a second transaction comprising one or more write operations to a second memory address. The first memory address and the second memory address may be mapped to the same controller for a hardware component and the one or more processing entities may commence execution of the second transaction after the first transaction starts execution and before the completion of the first transaction. The device may also include a transactional memory system configurable to communicate data written to the first memory address from the first transaction and the second memory address from the second transaction to the controller upon completion of the respective transactions.

### CROSS-REFERENCES TO RELATED APPLICATIONS

The present application is a non-provisional of and claims the benefit and priority under 35 U.S.C. 119(e) of (1) U.S. Provisional Application No. 61/845,934, filed Jul. 12, 2013, entitled TRANSACTIONAL MEMORY LAYER, and (2) U.S. Provisional Application No. 61/864,371, filed Aug. 9, 2013, entitled TRANSACTIONAL MANAGEMENT LAYER. The entire contents of the 61/845,934 and 61/864,371 applications are incorporated herein by reference for all purposes.

### BACKGROUND

Certain embodiments of the present invention provide techniques for providing reliable and efficient access to non-transactional resources, using transactional memory.

Traditionally, in a computing system, even though multiple processes may simultaneously or near simultaneously request access to a hardware component, such as an application-specific integrated circuit (ASIC), only one of the processes may acquire a lock and communicate with the hardware component at a time, thereby serializing access to the hardware component. The other processes must wait for the first process to release the lock before they can make progress. In most instances, the other processes may merely idle and ping the lock semaphore to check if the first process has relinquished the lock, so that the respective processes can make further progress. The wait for acquiring the lock by the other processes may be exasperated by the fact that performing input/output (I/O) operations to hardware components may take significantly longer to complete relative to other processor operations. Furthermore, the first process may hold the memory locked for an indeterminate period of time, until the process has completed several operations to the hardware component, such as writing to a graphics card or an Ethernet card.

Moreover, in the event of a failure during the execution of a process writing to a hardware component, known techniques do not provide support for recovering from such an error. For example, when a process belonging to an application is performing multiple writes to an ASIC, if the process encounters an error and fails, in prior art implementations the process may crash, possibly resulting in a catastrophic shutdown of the system. If errors occur during the write process the writes to the ASIC may be left in an indeterminate state and recovery may be difficult.

### BRIEF SUMMARY

Certain embodiments of the present invention provide techniques for providing reliable and efficient access to non-transactional resources, using transactional memory.

In certain embodiments, a transactional memory system may be implemented for allowing multiple processes to continue executing and modifying memory associated with the hardware component, concurrently. As described in further detail, in certain embodiments, various processes can modify non-overlapping memory associated with the hardware component, without blocking each other. Furthermore, in an event of error, techniques described herein may prevent catastrophic shutdowns by enabling a group of already executed operations to rollback without committing any changes to the hardware component itself.

In certain embodiments, an example device may include a memory and one or more processing entities. The processing entities may be configurable to execute a first transaction comprising one or more write operations to a first memory address, and a second transaction comprising one or more write operations to a second memory address. The first memory address and the second memory address may be mapped to the same controller for a hardware component. The one or more processing entities may commence execution of the second transaction after the first transaction starts execution and before the completion of the first transaction. The device may also include a transactional memory system configurable to communicate data written to the first memory address from the first transaction to the controller upon completion of the first transaction, and communicate data written to the second memory address from the second transaction to the controller upon completion of the second transaction. In some aspects, the execution of the one or more write operations to the first memory address from the first transaction does not block the execution of the one or more write operations to the second memory address from the second transaction and vice versa. In some implementations, the device is a network device.

In certain embodiments of the example device, the one or more processing entities may be further configurable to commence execution of a third transaction after the first transaction starts execution and before the completion of the first transaction, the third transaction comprising one or more write operations targeted to the first memory address, and the transactional memory system further configurable to block the execution of the third transaction until the completion of the first transaction and the update of the first memory location upon completion of the first transaction. In some instances, the first transaction may execute from a first process and the second transaction may execute from a second process.

In certain embodiments, a portion of memory is in a first state prior to commencing execution of operations from the first transaction by the one or more processing entities wherein, in response to a failure event, the one or more processing entities are further configurable to stop execution of the first transaction after execution of a subset of operations from the plurality of operations; and the transactional memory system may be further configurable to cause the state of the portion of memory to be in the first state.

In one implementation of the example device, causing the state of the portion of memory to be in the first state prior to commencement of the execution of the transaction by the second processing entity may include tracking changes to the portion of the memory by the first processing entity during the executing of the transaction on the first processing entity, and reverting the changes back to the first state prior to commencement of the execution of the transaction by the second processing entity.

In another implementation of the example device, causing the state of the portion of memory to be in the first state prior to commencement of the execution of the transaction by the second processing entity may include buffering changes directed to the portion of the memory during executing of the transaction in a memory buffer, and discarding the buffered changes in the memory buffer.

In certain embodiments, an example method for performing embodiments of the invention may include executing, by one or more processing entities, a first transaction comprising one or more write operations to a first memory address, executing, by the one or more processing entities, a second transaction comprising one or more write operations to a second memory address, wherein the one or more processing entities commence execution of the second transaction after the first transaction starts execution and before the completion of the first transaction, communicating data written to the first memory address from the first transaction to a controller upon completion of the first transaction, and communicating data written to the second memory address from the second transaction to the controller upon completion of the second transaction. In some aspects, the execution of the one or more write operations to the first memory address from the first transaction does not block the execution of the one or more write operations to the second memory address from the second transaction and vice versa.

Furthermore, the example method may include executing a third transaction, by the one or more processing entities, after execution and before the completion of the first transaction, the third transaction comprising one or more write operations targeted to the first memory address; and blocking the execution of the third transaction until the completion of the first transaction and the updating of the first memory location upon completion of the first transaction. In some instances, the first transaction may execute from a first process and the second transaction may execute from a second process.

In certain embodiments, the example method comprises stopping execution of the first transaction, by the one or more processing entities, in response to a failure event, and causing the state of a portion of memory to be in a first state, wherein the portion of memory is in the first state prior to commencing execution of the first transaction.

In one implementation of the example method, causing the state of the portion of memory to be in the first state prior to commencement of the execution of the transaction by the second processing entity may include tracking changes to the portion of the memory by the first processing entity during the executing of the transaction on the first processing entity, and reverting the changes back to the first state prior to commencement of the execution of the transaction by the second processing entity.

In another implementation of the example method, causing the state of the portion of memory to be in the first state prior to commencement of the execution of the transaction by the second processing entity may include buffering changes directed to the portion of the memory during executing of the transaction in a memory buffer, and discarding the buffered changes in the memory buffer.

In certain embodiments, an example non-transitory computer-readable storage medium may comprise instructions executable by one or more processing entities. The instructions may comprise instructions to execute a first transaction comprising one or more write operations to a first memory address; execute a second transaction comprising one or more write operations to a second memory address, wherein the one or more processing entities commence execution of the second transaction after the first transaction starts execution and before the completion of the first transaction; communicate data written to the first memory address from the first transaction to a controller upon completion of the first transaction; and communicate data written to the second memory address from the second transaction to the controller upon completion of the second transaction.

In certain embodiments, an example apparatus may include means for performing embodiments of the invention which may include executing, by one or more processing entities, a first transaction comprising one or more write operations to a first memory address; means for executing, by the one or more processing entities, a second transaction comprising one or more write operations to a second memory address, wherein the one or more processing entities commence execution of the second transaction after the first transaction starts execution and before the completion of the first transaction; means for communicating data written to the first memory address from the first transaction to a controller upon completion of the first transaction; and means for communicating data written to the second memory address from the second transaction to the controller upon completion of the second transaction. In some aspects, the execution of the one or more write operations to the first memory address from the first transaction does not block the execution of the one or more write operations to the second memory address from the second transaction and vice versa.

The foregoing has outlined rather broadly features and technical advantages of examples in order that the detailed description that follows can be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

FIG. 1 illustrates a system for communicating with a hardware component.

FIG. 2 illustrates a simplified block diagram of a computing device executing a simplified computer program according to one or more embodiments of the invention.

FIG. 3 illustrates a simplified block diagram for writing to memory allocated as transactional memory according to one embodiment of the invention.

FIG. 4 illustrates another simplified block diagram for writing to memory allocated as transactional memory according to another embodiment of the invention.

FIG. 5 illustrates a system for communicating with a hardware component, according to one or more embodiments of the invention.

FIG. 6 illustrates another system for communicating with a hardware component, according to one or more embodiments of the invention.

FIG. 7 depicts a simplified flowchart illustrating a method performed according to one or more embodiments of the invention.

FIG. 8 illustrates another example implementation of a device for communicating with a hardware component, according to aspects of the invention.

FIG. 9 depicts a simplified block diagram of a network device that may be configured to perform embodiments of the present invention.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

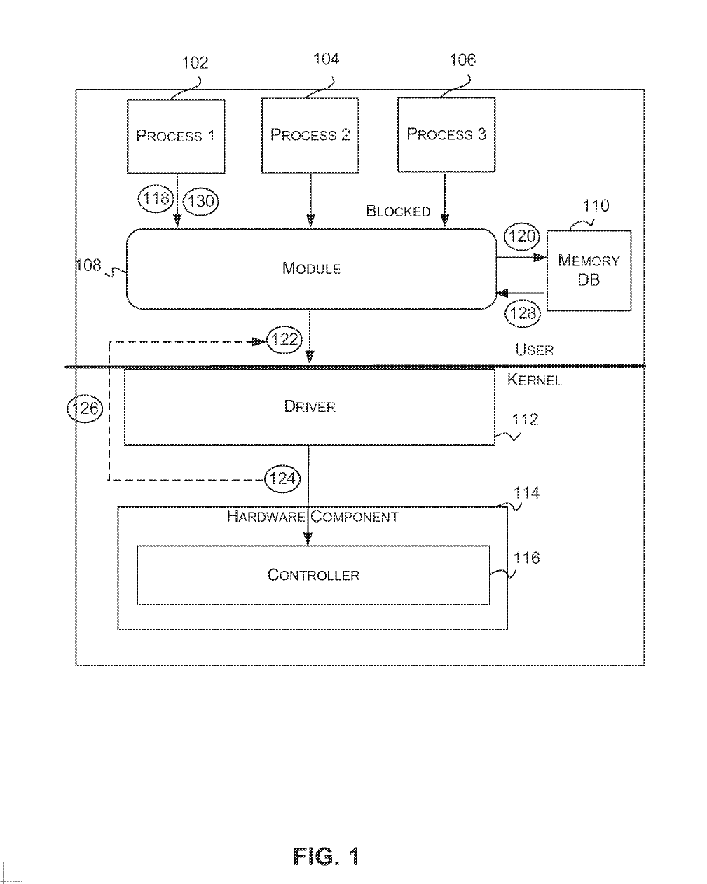

FIG. 1 illustrates a prior art system for communicating with a hardware component. FIG. 1 illustrates three processes (102, 104, and 106) simultaneously or near simultaneously requesting access to interact with a hardware component 114, such as an ASIC (application specific integrated circuit). The hardware component 114 may process input/output (I/O) requests through a controller 116. In certain implementations, receiving multiple requests, simultaneously or near simultaneously, from multiple processes by the controller 116, may result in data corruptions or corruption of the state of the hardware component 114. Such corruptions may lead to other corruptions in the system, malfunctioning of software or even a forced shutdown of the system. Therefore, the I/O requests to the controller 116 may need to be realized in a serialized manner.

In certain implementations, the controller 116 of the hardware component 114 may be accessible from one or more processes through memory mapped I/O. In such an implementation of the system, a write operation to memory reserved for the hardware component may be translated by the system as an I/O operation to the controller 116 of the hardware component 114. A process vying for access to the hardware component 114 may request for exclusive access to the memory mapped to the hardware component 114.

As shown in FIG. 1, a process running on the system may access the hardware component through a device driver 112, by initiating a library call to a module 108 provided by the operating environment, such as the operating system. The operating system may operate software in several different privilege levels, such as user privilege level and kernel privilege level, providing different levels of access to the system resources. For example, a portion of the operating system executing in the kernel privilege level may have direct access to hardware resources associated with the system. On the other hand, a portion of the operating system executing in the user privilege level may be restricted from directly manipulating hardware resources of the system. In one implementation, as depicted in FIG. 1, the processes and the module 108 may execute in the user privilege level, and the device driver 112 may operate in the kernel privilege level. The process operating in the user privilege level may request access to the hardware component 114 through the module 108 (also operating in the user privilege level) that in turn calls the device driver 112 operating in the kernel privilege level. The device driver 112 can access and pass along the read and write requests from the process to the hardware component 114.

In an example scenario, as depicted in FIG. 1, processes 102, 104 and 106 may simultaneously or near simultaneously request access to the hardware component 114. At step 118, the process 1 (102) may call the module 108 for communicating with a hardware component 114. In one implementation, the module 108 may serialize access to the hardware component 114. For instance, the module 108 may use known techniques, such as lock-based synchronization techniques for exclusively locking access to the hardware component 114 for process 1 (102). For example, at step 120, the module 108 may request the memory database 110 to lock access to specific memory locations mapped to the hardware component 114, and return back the success/failure of the status of the lock, in step 128.

Once the lock is acquired by the process 1 (102), at step 122, the module 108 may make the ioctl( ) function call to the hardware driver 112 for accessing the hardware component 114, at step 124. In some instances, the hardware driver may hold memory locked for an extended period of time. For example, the driver may hold the memory locked for performing several operations (step 126) to the hardware component 114.

Even though the first process 102, the second process 104 and the third process 106 may simultaneously or near simultaneously request access to the hardware component 114, only one of the three processes may acquire the lock to communicate with the hardware component 114, thereby serializing access to the hardware component 114. Therefore, the second process 104 and the third process 106 wait for the first process 102 to release the lock before they can make progress. In most instances, the second process 104 and the third process 106 may merely idle and ping the lock semaphore to check if the first process 102 has relinquished the lock, so that the respective processes can make further progress. The wait for acquiring the lock by the second process 104 and the third process 106 may be exasperated by the fact that performing input/output (I/O) operations to hardware components may take significantly longer to complete relative to other processor operations. Furthermore, the first process 102 may hold the memory locked for an indeterminate period of time, till the process has completed several operations to the hardware component, such as writing to a graphics card or an Ethernet card.

Moreover, in the event of a failure during the execution of a process writing to a hardware component 114, known techniques do not provide support for recovering from such an error. For example, in FIG. 1, when a process belonging to an application is performing multiple writes to an ASIC using ioctl( ) operations, if the process encounters an error and fails, in some prior art implementations the process may crash, possibly resulting in a catastrophic shutdown of the system. If errors occur during the write process (i.e., step 126) the writes to the ASIC may be left in an indeterminate state and recovery may be difficult.

In certain embodiments, a transactional memory system may be implemented for allowing multiple processes to continue executing and modifying memory associated with the hardware component 116, concurrently. As described in further detail below, in certain embodiments, various processes can modify non-overlapping memory associated with the hardware component 116, without blocking each other. Furthermore, in an event of error, techniques described herein may prevent catastrophic shutdowns by enabling a group of already executed operations to rollback without committing any changes to the hardware component itself.

In certain embodiments, the transactional memory system ensures the consistency of data stored in the transactional memory at a transaction level, where the transaction may comprise one or more operations. The transactional memory system guarantees that changes to the transactional memory caused by write and/or update operations are kept consistent at the level or atomicity of a transaction. The transactional memory system treats a transaction as a unit of work; either a transaction completes or does not. The execution of a transaction is considered to be completed if all the sequential operations defined for that transaction are completed. The execution of a transaction is considered not to be completed, i.e., considered to be incomplete, if all the sequential operations defined for that transaction are not completed. In terms of software code, a transaction represents a block of code and the transactional memory system ensures that this block of code is executed atomically. The transactional memory system ensures that changes to memory resulting from execution of the operations in a transaction are committed to the transactional memory only upon completion of the transaction. If a transaction starts execution but does not complete, i.e., all the operations in the transaction do not complete, the transactional memory system ensures that any memory changes made by the operations of the incomplete transaction are not committed to the transactional memory. Accordingly, the transactional memory system ensures that an incomplete transaction does not have any impact on the data stored in the transactional memory. The transactional memory system thus ensures the consistency of the data stored in the transactional memory at the boundary or granularity of a transaction.

A transactional memory system may use different techniques to ensure that any memory changes caused by operations of a transaction are committed to the transactional memory only upon completion of the transaction, or alternatively, to ensure that any memory changes caused by operations of an incomplete transaction are not committed to the transactional memory.

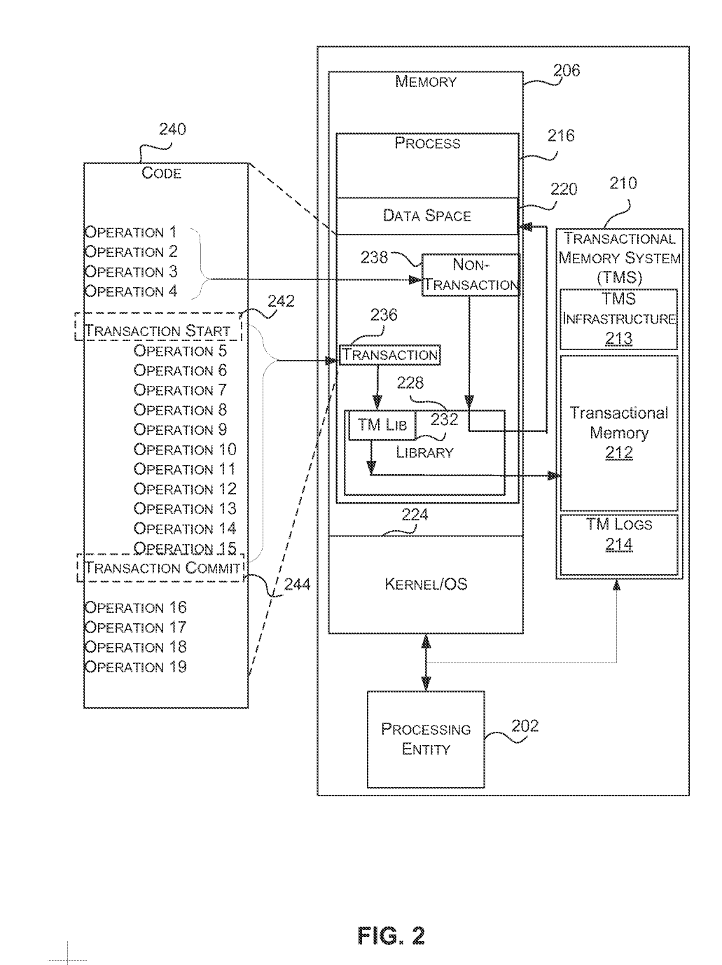

FIG. 2 illustrates a simplified block diagram of a computing device 200 according to one or more embodiments of the invention. An example of a computing device may include a network device. Examples of network devices include devices such as routers or switches that are configured to route or forward data (e.g., packets) in a network. Examples of such network devices include various devices provided by Brocade Communications Systems, Inc. of San Jose, Calif. The computing device 200 depicted in FIG. 2, including its various components, is meant for illustrative purposes only and is not intended to limit the scope of the invention in any manner. Alternative embodiments may have more or fewer components than those shown in FIG. 2.

For illustration purposes, FIG. 2 shows one processing entity 202; however, computing device 200 may include multiple processing entities. A processing entity may be a processor, a group of physical processors, a core of a multicore processor, a group of cores of one or more multicore processors, and combinations thereof.

For example, in one embodiment, a processing entity of computing device 200 may be a physical processor, such as an Intel, AMD, or TI processor, or an ASIC. In another embodiment, a processing entity may be a group of processors. In another embodiment, a processing entity may be a processor core of a multicore processor. In yet another embodiment, a processing entity may be a group of cores from one or more processors. A processing entity can be any combination of a processor, a group of processors, a core of a processor, or a group of cores of one or more processors.

In certain embodiments, the processing entity may be a virtual processing unit or a software partitioning unit such as a virtual machine, hypervisor, software process or an application running on a processing unit, such as a physical processing unit, core or logical processor. For example, the one or more processing entities may be virtual machines executing or scheduled for execution on one or more physical processing units, one or more cores executing within the same physical processing unit or different physical processing units, or one or more logical processors executing on one or more cores on the same physical processing unit or separate physical processing units.

In certain implementations, each processing entity may have a dedicated portion of memory assigned to or associated with the processing entity. In one embodiment, the memory assigned to a processing entity is random access memory (RAM). Non-volatile memory may also be assigned in other embodiments. For example, in the embodiment depicted in FIG. 2, the processing entity 202 is coupled to memory 206.

Software instructions (e.g., software code or program) that are executed by a processing entity may be loaded into the memory 206 coupled to that processing entity 202. This software may be, for example, loaded into the memory upon initiation or boot-up of the processing entity. In one embodiment, as depicted in FIG. 2, the loaded software may include an operating environment (OS) and/or kernel 224, along with various drivers, computer applications, and other software modules. In one embodiment, if computing device 200 is a network device, a network operating system (NOS) also may be loaded into the memory after the operating system has been loaded.

As depicted in FIG. 2, memory 206 is associated with first processing entity 202. One or more applications may be loaded into memories 206 by the processing entity 202. An application may comprise one or more processes that are executed by the processing entities. In some embodiments, a process may be an instantiation of an application or computer program.

For example, as shown in FIG. 2, a process 216 may be loaded into a portion of memory 206 and executed by processing entity 202. The process may have its own memory space (data space) for storing and manipulating data (e.g., data space 220) during execution of the process. In certain implementations, a process may have multiple threads/streams of operations for executing operations concurrently.

In certain embodiments, a transactional memory system (TMS) 210 is provided to facilitate non-blocking execution of operations to hardware components from a process executing on the processing entity 202. As depicted in FIG. 2, transactional memory system 210 comprises a transactional memory 212 and an infrastructure 213 that guarantees consistency of data stored in transactional memory 212 at the atomicity of a transaction. In certain embodiments, transactional memory 212 can be shared between multiple processing entities of computing device 200.

Memory 206 and transactional memory 212 may be physically configured in a variety of ways without departing from the scope of the invention. For example, memory 206 and transactional memory 210 may reside on one or more memory banks connected to the processing entities using shared or dedicated busses in computing device 200.

As shown in FIG. 2, transactional memory system 210 also comprises an infrastructure 213 that guarantees consistency of data stored in transactional memory 212 at the atomicity of a transaction. In conjunction with transactional memory 212, the infrastructure 213 guarantees that changes to transactional memory 212 caused by write and/or update operations are kept consistent at the level or atomicity of a transaction. Transactional memory system 210 ensures that changes to memory 212 resulting from execution of the operations in a transaction are committed to transactional memory 212 only upon completion of the transaction. If a transaction starts execution but does not complete, i.e., all the operations in the transaction do not complete, transactional memory system 210 ensures that any memory changes made by the operations of the incomplete transaction are not committed to transactional memory 212. Accordingly, transactional memory system 210 ensures that an incomplete transaction does not have any impact on the data stored in transactional memory 212. Transactional memory system 210 thus ensures the consistency of the data stored in transactional memory 212 at the boundary or granularity of a transaction. For example, in one embodiment, if a transaction executed by a processing entity encounters an event during the execution of the transaction that causes execution of the transaction to stop execution without completing all of the operations for the transaction, transactional memory system 210 may cause any memory changes resulting from the execution of the operations of the incomplete transaction to be rolled back as if those operations were never executed.

Transactional memory system 210 may be implemented using several software or hardware components, or combinations thereof. In one embodiment, the infrastructure 213 may be implemented in software, for example, using the software transactional memory support provided by GNU C Compiler (GCC) (e.g., the libitm runtime library provided by GCC 4.7). Infrastructure 213 may also be implemented in hardware using transactional memory features provided by a processor. Transactional memory system 210 may also be provided using a hybrid (combination of software and hardware) approach.

In certain embodiments, a process executed by a processing entity may make use of transactional memory system 210 by linking to and loading a runtime library 232 (e.g., the libitm library provided by GCC 228) that provides various application programming interfaces (APIs) that make use of transactional memory system 210. Operations that belong to a transaction may make use of the APIs provided by such a library such that any memory operations performed by these operations use transactional memory system 210 instead of non-transactional memory. Operations that do not want to use transactional memory system 200 may use APIs provided by non-transactional libraries such that any memory operations performed using these non-transactional memory APIs use data space 220 instead of transactional memory system 210. For example, as shown in FIG. 2, a transactional operation 236 may use APIs provided by a transactional memory library (TM lib) 232 that causes transactional memory system 210 to be used for any memory operations; and a non-transactional operation 238 may use non-transactional memory libraries/APIs. For example, in one implementation, operations in a transaction that use transactional memory system 210 may be routed through TM lib 232, which provides the interface to interact with the transactional memory system 210. TM lib 232 may provide APIs for allocation of transactional memory 212, reading and writing to transactional memory 212, and the like. In this manner, all memory-related operations in a transaction are routed via TM lib 232 to transactional memory system 210.

In certain implementations, transactional memory system 210 uses TM logs 214 to guarantee consistency of data stored in transactional memory 212 on a per transaction basis. In one embodiment, for a sequence of operations in a transaction, information tracking changes to transactional memory 212, due to execution of the operations of the transaction, are stored in TM logs 214. The information stored is such that it enables transactional memory system 210 to reverse the memory changes if the transaction cannot be completed. In this manner, the information stored in TM logs 214 is used by transactional memory system 210 to reverse or unwind any memory changes made due to execution of operations of an incomplete transaction.

For example, for a transaction that comprises an operation that writes data to a memory location in transactional memory 212, information may be stored in a TM log 214 related to the operation and the memory change caused by the operation. For example, the information logged to a TM log 214 by transactional memory system 210 may include information identifying the particular operation, the data written by the operation or the changes to the data at the memory location resulting from the particular operation, the memory location in transactional memory 212 where the data was written, and the like. If for some reason the transaction could not be completed, transactional memory system 210 then uses the information stored in TM log 214 for the transaction to reverse the changes made by the write operation and restore the state of transactional memory 212 to a state prior to the execution of any operation in the transaction as if the transaction was never executed. For an incomplete transaction, the TM log information is thus used to rewind or unwind the transactional memory changes made by any executed operations of an incomplete transaction. The memory changes made by operations of an incomplete transaction are not committed to transactional memory 212. The memory changes are finalized or committed to memory only after the transaction is completed. TM logs 214 themselves may be stored in transactional memory 212 or in some other memory in or accessible to transactional memory system 110.

As depicted in FIG. 2, process 216 loaded into memory 206 and executed by processing entity 202 may contain code 240 comprising a plurality of sequential operations (e.g., code instructions). One or more blocks of code (e.g., a set of sequential operations) of code 240 may be tagged as transactions. In the example depicted in FIG. 2, the set of operations from operation_{—}5 to operation_{—}15 is tagged as belonging to single transaction 236 whereas the other operations are not tagged as belonging to any transaction. The transaction is demarcated using “transaction start” (242) and “transaction commit” (244) delimiters. In one embodiment, the “transaction start” and “transaction commit” delimiters indicate to transactional memory system 210 that the operations 5-15 are considered part of the same transaction 236, whereas the operations outside the “transaction start” and “transaction commit” demarcations are considered non-transactional operations 238.

The operations that make up a transaction are generally preconfigured. In one embodiment, a system programmer may indicate what operations or portions of code constitute a transaction. A piece of code may comprise one or more different transactions. The number of operations in one transaction may be different from the number of operations in another transaction. For example, a programmer may define a set of related sequential operations that impact memory as a transaction.

When code 240 is executed due to execution of process 216 by processing entity 202, operations that are part of a transaction, such as operations 5-15, use the transactional memory APIs provided by TM lib 232, and as a result, transactional memory 212 is used for the memory operations. Operations that are not part of a transaction, such as operations 1-4 and 16-19, use a non-transactional memory library and, as a result, any memory operations resulting from these operations are made to data space 220 within the memory portion allocated for process 216 in memory 206.

For a transaction, the block of code corresponding to operations in the transaction is treated as an atomic unit. In one embodiment, the “transaction start” indicator (or some other indicator) indicates the start of a transaction to first processing entity 202 and the “transaction commit” indicator (or some other indicator) indicates the end of the transaction. The operations in a transaction are executed in a sequential manner by processing entity 202. As each transaction operation is executed, if the operation results in changes to be made to transactional memory 212 (e.g., a write or update operation to transactional memory 212), then, in one embodiment, the information is logged to a TM log 214. In this manner, as each operation in a transaction is executed, any memory changes caused by the execution operation is logged to TM log 214. If all the operations in the transaction (i.e., operations 5-15 for the transaction shown in FIG. 2) are successfully completed, then the changes made to transactional memory 212 are made permanent or committed to transactional memory 212. However, if the transaction could not successfully complete, then any transactional memory 212 changes made by executed operations of the incomplete transaction are reversed using information stored in TM logs 214. In this manner, the changes made by an incomplete transaction are not committed to transactional memory 212.

For example, while executing code 240, the processing entity 202 may receive an event that causes code execution by processing entity 202 to be interrupted. If the interruption occurs when the transaction comprising operations 5-15 is being executed, then any transactional memory 212 changes made by the already executed operations of the incomplete transaction are reversed, using information stored in TM logs 214. For example, if the interruption occurs when operation_{—}9 has been executed and operation_{—}10 is about to be executed, any changes to transactional memory 212 caused by execution of operations 5-9 are reversed and not committed to transactional memory 212. In this manner, transactional memory system 210 ensures that the state of data stored in transactional memory 212 is as if the incomplete transaction was never executed.

In certain embodiments, the transactional memory 112 and the TM log 114 may be implemented using memory that is persistent across a failover. During the reboot, the power planes associated with the processing entities and the memory may also be rebooted. Rebooting of the power planes may result in losing of the data stored in memory. In certain embodiments, to avoid losing data stored in the transactional memory 212 and the TM logs 114, the library may allocate the memory using persistent memory. In one implementation, persistent memory may be implemented using non-volatile memory, such as flash, that retains data even when not powered. In another implementation, persistent memory may be implemented by keeping the memory powered during the period when the computing device 100 reboots. In some implementations, the transactional memory 212 and the TM logs 114 may be implemented on a separate power plane so that they do not lose power and consequently data while other entities in the network device lose power and reboot.

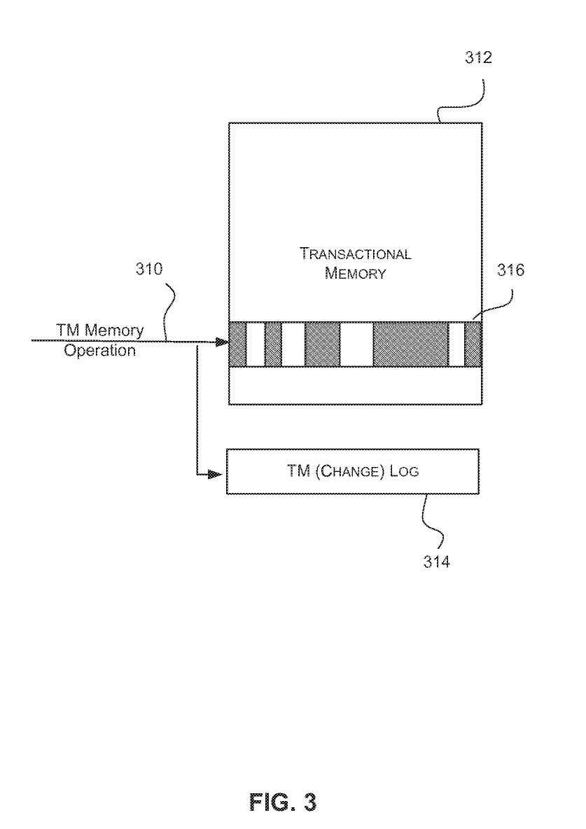

FIG. 3 illustrates a simplified block diagram for writing to transactional memory allocated as part of the transactional memory system according to certain embodiments of the invention. In FIG. 3, execution of TM memory operations 310 may result in changes to the transactional memory 312, maintained as part of the transactional memory system, and may be stored to the transactional memory 312 itself. Along with storing the change to transactional memory 312, the changes or representation of the changes are also stored in the TM logs 314. The TM logs 314 may also be referred to as change logs. In certain embodiments, the transactional memory system uses TM logs 314 to guarantee consistency of data stored in transactional memory 316 on a per transaction basis. In one embodiment, for a sequence of operations in a transaction, information tracking changes to a portion of the transactional memory 316 due to execution of the operations of the transaction is stored in the TM log 314. The information stored is such that it enables the transactional memory system to reverse the memory changes if the transaction cannot be completed. In this manner, the information stored in TM logs 314 is used by the transactional memory system to reverse or unwind any memory changes made due to execution of operations of an incomplete transaction.

For example, for a transaction that comprises an operation that writes data to a memory location in transactional memory 316, information may be stored in a TM log 214 related to the operation and the memory change caused by the operation. For example, the information logged to a TM log 314 by the transactional memory system may include information identifying the particular operation, the data written by the operation or the changes to the data at the memory location resulting from the particular operation, the memory location in transactional memory where the data was written, and the like. If, for some reason, the transaction could not be completed, transactional memory system 210 then uses the information stored in TM log 214 for the transaction to reverse the changes made by the write operation and restore the state of the portion of the transactional memory 316 to a state prior to the execution of any operation in the transaction as if the transaction was never executed. For an incomplete transaction, the TM log information is thus used to rewind or unwind the transactional memory changes made by any executed operations of an incomplete transaction. The memory changes made by operations of an incomplete transaction are not committed to memory 312. The memory changes are finalized or committed to memory only after the transaction is completed. TM logs 314 themselves may be stored in transactional memory 312 or in some other memory in or accessible to transactional memory system.

As described earlier, the changes to the portion of the transactional memory 316 are committed to transactional memory 312 at the transaction boundary. For example, in FIG. 2, the changes are committed upon execution of the “transaction commit” 244. In one implementation, committing the changes to transactional memory at the transaction boundary may refer to updating the entries in the TM log 314 so that the changes from the completed transaction are no longer preserved in the TM log 314 and may be overwritten by subsequent writes. In one implementation, after completion of the transaction, the TM log 314 may no longer support rolling back of the changes made to the transactional memory by operations from the transaction. In FIG. 3, if the transaction stops without completing the transaction, the changes to the transactional memory 212 may be rolled back, using information stored in the TM logs 314.

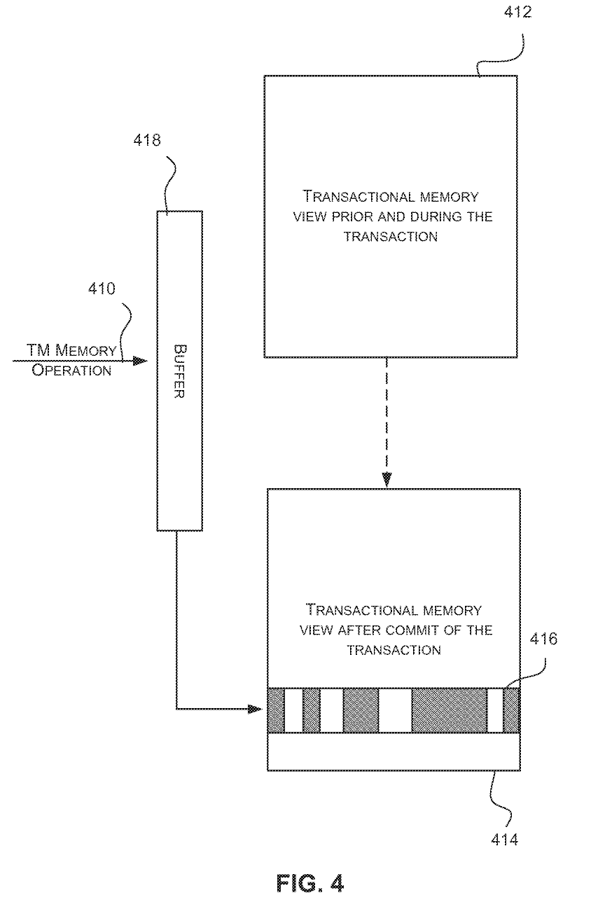

FIG. 4 illustrates a simplified block diagram for writing to transactional memory allocated as part of the transactional memory system, according to another embodiment of the invention. As depicted in FIG. 4, in the transaction memory system, the intended changes for memory locations 416 by the TM memory operations 410 during the execution of a transaction are buffered in one or more buffers 418. The changes targeted for transactional memory 412 are not written to the transactional memory 412 until the completion of the transaction (as shown in block 414). Transactional memory 412 depicts the view of memory before and during the execution of the transaction, whereas transactional memory 414 depicts the view of the memory once the transaction is completed and committed. At completion of the transaction, the changes buffered in the buffer 418 are committed to the transactional memory. In some implementations, committing the changes to transactional memory may refer to pushing out the changes from the buffer 418 to the transactional memory once the transaction completes.

In one implementation, the buffer 418 shown in FIG. 4 may be implemented using a write-back cache in a processor. For example, write-back caches in a processor operate by writing back the contents of any particular location of the cache to memory at the time the data at the location in the cache is evicted (e.g., pushed out of the cache to be stored in memory—usually due to storing of another value at the same cache location). Reading and writing directly from cache instead of memory result in much faster execution of operations.

In one implementation of a cache-based transactional memory system, all memory write operations during the execution of the transaction to the memory region reserved as the transactional memory 412 region may be written to the processor cache instead of the transactional memory 412. The memory write operations during the execution of the transaction to the memory region reserved as the transactional memory 412 region may also be tagged as transactional memory stores in the cache. In one implementation, during the execution of the transaction, the stores tagged as transactional memory stores in the processor are preserved in the caches and protected from evictions (i.e., being pushed out to the memory) until the completion of the transaction.

At the completion of the execution of the transaction, all the stores targeted to the transactional memory 412 are committed to the memory 416. In the above example implementation, committing of the memory operations to transactional memory 416 may refer to evicting all the transaction memory writes stored in the caches to the transactional memory 414.

In FIG. 4, transactional memory 412 shows a view of the memory before or during the execution of the transaction, whereas transactional memory 414 shows a view of the same memory space after the completion of the transaction. In memory 414, the completion and committing of the transaction results in memory stores are buffered in the temporary buffer 418 before being flushed out to the transactional memory (as shown as block 416).

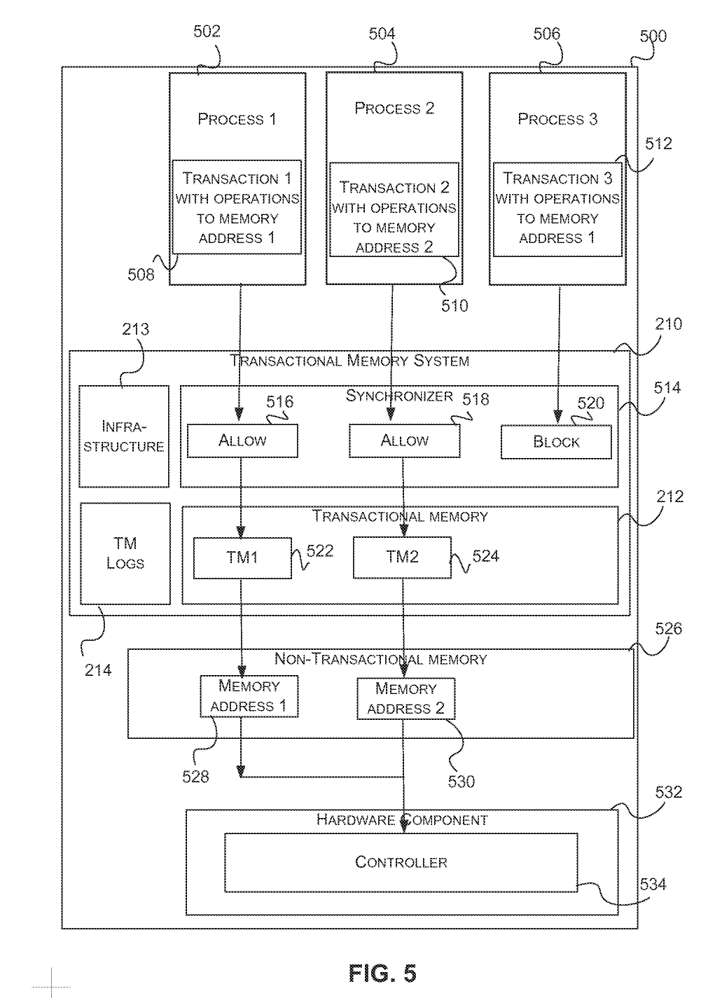

FIG. 5 illustrates a system for communicating with a hardware component 532, according to one or more embodiments of the invention. FIG. 5 illustrates a device 500 with three processes (502, 504, and 506) simultaneously or near simultaneously requesting access to interact with a hardware component 532, such as an ASIC (application specific integrated circuit). The hardware component 532 may process input/output (I/O) requests through a controller 534. In certain implementations, receiving multiple requests simultaneously or near simultaneously from multiple processes at the controller 534 may result in data corruptions or corruption of the state of the hardware component 532. Such corruptions may lead to other corruptions in the system, malfunctioning of the software or forced shutdown of the system. Therefore, the I/O requests received at the controller 534 may need to be serialized before reaching the controller 534 for the hardware component 532.

In certain embodiments, each process may request access to the hardware component 532 through a transactional memory system 210. For each process, the operations for accessing the hardware component 532 may be initiated from within a transaction associated with the process. For example, the first process 502 may initiate a first transaction 508 with read and write operations to a first non-transactional memory region 528 associated with the hardware component 532, a second process 504 may initiate a second transaction 510 with read and write operations to a second non-transactional memory region 530 associated with the hardware component 532, and a third process 506 may initiate a third transaction 512 with read and write operations again to the first non-transactional memory region 528 associated with the hardware component 532.

In certain implementations, the various processes may initiate access to the hardware component 532 from inside a transaction in a variety of ways. For example, the developer of the process at the time of development may programmatically initiate a transaction before requesting access to a hardware component 532 and complete the transaction after executing all of the operations targeted to the hardware component 532. In certain other implementations, the operating environment, such as the transactional memory system 210, may provide the mechanisms for transactionally executing access requests to the hardware components. For example, the process may request to write to a network card in the device 500 using a networking API supported by the library 228. In one implementation, for writing data to the network card, the process may call the API with a pointer to a temporary buffer in memory with the data. The size of the buffer may be of variable sizes, requiring multiple writes to the network card. In one implementation, the TM lib 232 is invoked by the networking API for writing data to the network card. In one implementation, the TM lib 232 may embed the request for access to the network card within a transaction.

Referring back to FIG. 5, the first process 502 and the second process 504 may simultaneously or near simultaneously request access to different memory regions (or addresses) associated with the hardware component 532. In an example scenario, the second process 504 may initiate execution of the second transaction 510 requesting access to the hardware component 532 after the first process 502 initiates execution of the first transaction 508 and before the first process 502 completes execution of the first transaction 502. In certain implementations, the transactional memory system 210, at a synchronizer 514, may check requests to initiate a transaction with access requests to the same hardware component 532 from the two different processes to ensure that the access requests do not overlap in memory regions. As illustrated in FIG. 5, the synchronizer 518, checks the request for executing the first transaction 508 by the first process 502 at block 516. Since, no pending transactions exist before the execution of the first transaction 508, the synchronizer 514 allows execution (block 516) of the first transaction 508. The second process 504 executes the second transaction 510 with requests to the same hardware component 532 (but different memory region/address) after the first transaction 508 starts executing and before completion of the first transaction 510. The synchronizer 514 checks any potential overlap in access to the memory regions by the two processes and allows the second transaction 512 to progress (block 518), since the two processes are accessing different memory regions/addresses (528 and 530, respectively).

The memory operations executing from the first transaction 508 and the second transaction 510 are completed in transactional memory space (TM1 522 and TM2 524, respectively) managed by the transactional memory system 210. Any modifications to the transactional memory during the execution of the transaction are committed to the non-transactional memory (528 and 530) hardware component 532 only upon completion of the respective transaction. For instance, the modifications to TM1 522 by the first transaction 508 are committed to the first non-transactional memory region/address 528 associated with the hardware component only upon completion of the first transaction 508. Since the memory operations executing within each transaction are not committed to the non-transactional memory associated with the hardware component 532 until completion of the respective transactions, both transactions can execute simultaneously completing memory operations targeted to the hardware component. Referring to FIG. 5, since the first transaction 508 and the second transaction 510 comprise memory operations targeted to different regions or addresses of the non-transactional memory, both transactions can execute simultaneously or near simultaneously.

Completion of the memory operation, as part of the transaction, may refer to the completion of the execution of the memory operation by the processing entity, allowing the forward progress of the subsequent instructions in the transaction. At the completion of all the operations in the transaction, the changes to the transactional memory are committed to memory. The committing of the changes to non-transactional memory 526 may result in the changes to the respective addresses in memory being pushed out to the hardware component 532. In one implementation, the memory controller (not shown) may translate the memory operations to the respective memory sections reserved for the hardware component 532 to I/O writes to the hardware component 532. In certain embodiments, the transactional memory system 210 may be further configured to commit only one transaction at a time, or commit only one transaction associated with a non-transactional memory region at one time to avoid collisions between the memory operations associated with the same hardware component 532 from different transactions.

In FIG. 5, the third process 506 is shown as also initiating a request to access the hardware component 532 using a third transaction 512. In an example scenario, the third transaction 512 may also request execution after the start of the first transaction 508 and before completion of the first transaction 508. The memory operations in the third transaction 512 may have access requests to the same memory regions or addresses as the first transaction 508. The transactional memory system 210 may receive the request to execute the third transaction 512. The synchronizer 514 component of the transactional memory system 210 may determine that the access requests to the memory regions or address from the third transaction 512 overlap with the currently operating accesses for the first transaction 508. In response to determining that there is an overlap between the requests to access the memory regions between the third transaction 512 and the first transaction 508, in one implementation, the synchronizer 514 may block the execution of the third transaction 512 (block 520) until the completion and commitment of the first transaction 508.

The transactional memory 212 and the non-transactional memory 526 may be implemented using a variety of techniques without departing from the scope of the invention. For example, in implementations of transactional memory system 210 similar to the implementation discussed with reference to FIG. 3, where the modifications to memory are immediately observable in the memory, the transactional memory and the non-transactional memory may be implemented as separate memory regions, as shown in FIG. 5. In some instances, the transactional memory 212 may act as a shadow memory for writes to the non-transactional memory. Once the transaction is completed, all changes to the memory (as indicated in the TM logs 214) for the transaction may be pushed to the non-transactional memory 526 layer. On the other hand, if the transaction is interrupted without completion of the transaction, the transactional memory system 210 may revert the changes to the memory using the changes indicated in the TM logs 214. In such a scenario, the incomplete changes in the transactional memory 212 for the transaction do not reach the non-transactional memory 526, and from the perspective of the non-transactional memory 526 and the hardware component 532, it appears as if the transaction was never executed. At a later point in time, the same transaction may be restarted and, upon completion of the transaction, the changes associated with the memory operations from the transaction may be forwarded to the hardware component 532.

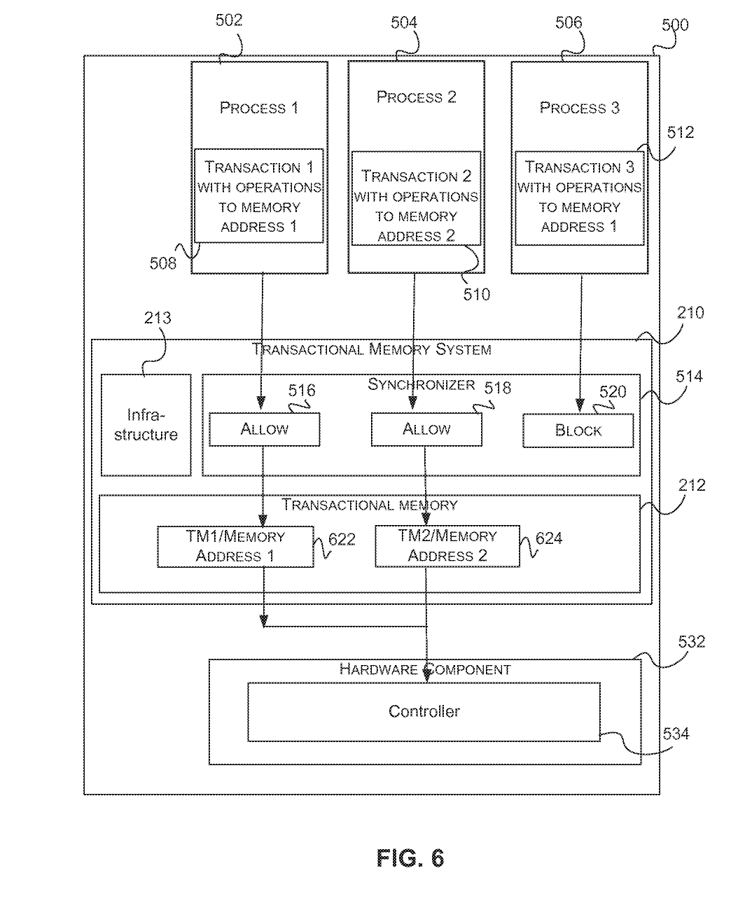

FIG. 6 illustrates another system for communicating with a hardware component 532. FIG. 6 illustrates another example implementation of the system described in FIG. 5. Instead of implementing two separate memory spaces, as shown in FIG. 5 (transactional memory 212 and non-transactional memory 526), for writing from the same transaction to the same memory region of the hardware component 532, a combined transactional memory 212 may be implemented in FIG. 6 for writing from the same transaction to the memory region of the hardware component 532. Furthermore, in FIG. 6, in certain implementations, the TM logs 214 may be optional.

In an implementation of the transactional memory system 210, similar to the implementation discussed with reference to FIG. 4, the changes targeted for the transactional memory space are stored in a buffer, such as a processor cache (separate from the system memory) and committed to memory upon completion of the transaction. In such an implementation of the transactional memory system 210, the changes targeted for the memory by the memory operations may not be observable in the memory itself until the completion of the transaction. In such an implementation, if the transaction fails to complete, the changes stored in the buffers, such as the cache, are discarded and the memory is not updated.

In such an implementation of the transactional memory system, implementation of a separate non-transactional memory may not be needed. Portions of the transactional memory 212 may be directly mapped to the hardware component 532. As the transactions execute on the processing entities, the changes targeted to the memory mapped to the hardware component 532 are temporarily stored in the processing buffers, such as caches and are not observable in the transactional memory (622 and 624). Upon completion of the transactions, the respective changes to the memory, stored in the buffer, are committed to the transaction memory, i.e., pushed out from the buffers and written to the transactional memory. At the completion of the transaction, when the memory operations are committed to the transactional memory, in certain implementations, the memory controller may convert the memory operations to I/O operations directed to the hardware components 532.

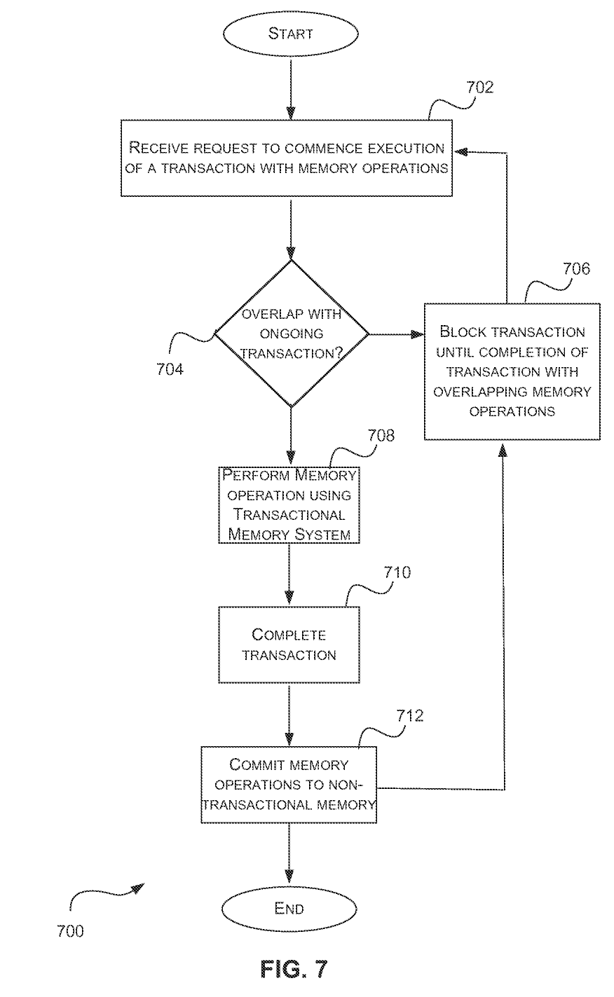

FIG. 7 depicts a simplified flowchart 700 illustrating a method performed according to one or more embodiments of the invention. According to one or more aspects, any and/or all of the methods and/or method steps described herein may be implemented by components of the network device 700 described in FIG. 7. In other implementations, the method may be performed by components of the network device described in FIG. 1-6. In one embodiment, one or more of the method steps described below with respect to FIG. 7 are implemented by one or more processing entities of the network device. Additionally or alternatively, any and/or all of the methods and/or method steps described herein may be implemented in computer-readable instructions, such as computer-readable instructions stored on a computer-readable medium such as the memory, storage or another computer readable medium.

At step 702, components of the device may receive a request to commence execution of a transaction with memory operations targeted to a hardware component. At step 704, components of the device may check if the memory operations from the transaction targeted for the hardware component overlap with memory operations of one or more currently executing transactions for the same memory addresses. In certain implementations, the device may check for overlap in specific regions or a range of addresses rather than just specific addresses.

At step 704, if the request for execution of the transaction has an overlap in memory operations with currently executing transactions, then components of the device, at step 706, may block the execution of the transaction until completion of the currently executing transactions with overlapping memory operations. Once the currently executing transaction with the overlapping memory operations completes and commits the changes to memory, the request for execution of the transaction may be unblocked. Components of the device may again request execution of the transaction at step 702.

On the other hand, if, at step 704, components of the device do not find any overlap in memory operations with currently executing transactions, then, at step 708, components of the device may perform operations from the transaction including memory operations using the transactional memory system 210. According to certain implementations of the device, the changes resulting from executing of the memory operations from the transaction are not observable at the memory mapped to the hardware component during the execution of the transaction.

At step 710, the operations of the transaction are completed. At step 712, upon completion of the transaction, the changes to the memory from the execution of the memory operations from the transaction are committed to the memory mapped to the hardware component. In addition to committing the changes to memory, at step 712, components of the device may indicate to the synchronizer 514 in the transactional memory system that any blocked transactions waiting to access the same memory addresses as the completed transaction may be unblocked.

It should be appreciated that the specific steps illustrated in FIG. 7 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination therebetween. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

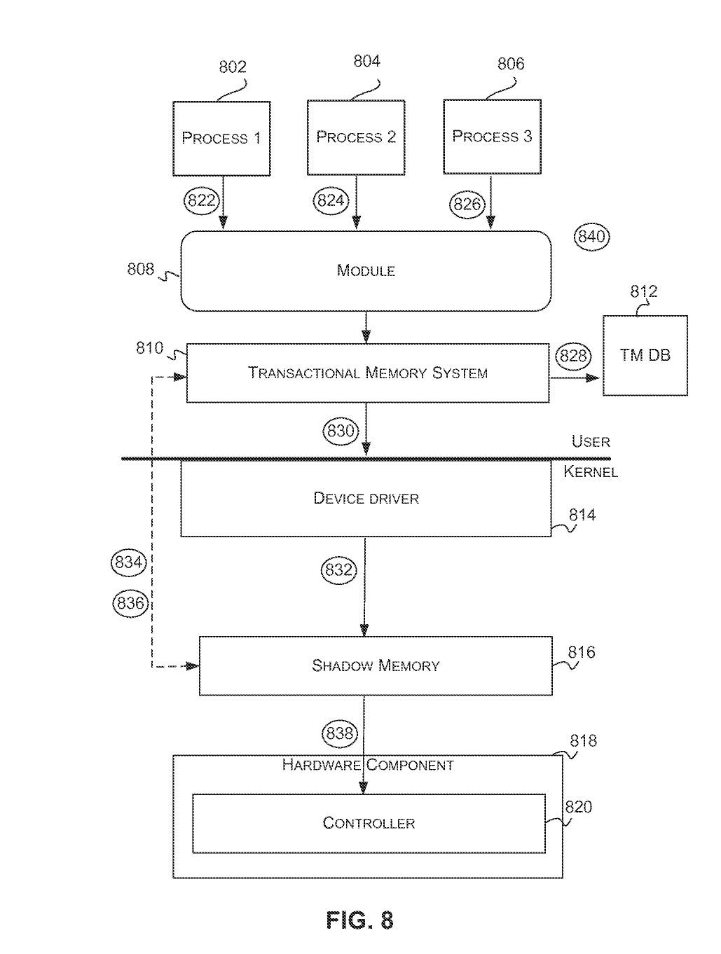

FIG. 8 illustrates another example implementation of a device for communicating with a hardware component 818, according to aspects of the invention. As illustrated in FIG. 8, according to certain embodiments of the invention, three processes (802, 804 and 806) may execute simultaneously or near simultaneously to each other. Each process may call the module 808 (822, 824 and 826) and block. The transactional memory system 810 may initiate a transaction (not shown) for each of process calls (822, 824 and 826). The transactional memory system may also manage the memory associated with the transactions (step 828) in the transactional memory database 812 (TM DB).

At step 830, the transactional memory system 810 may initiate ioctl( ) calls to the driver 814 operating in the kernel privilege level to communicate with the hardware component 818. As step 832, the device driver 814 may update the shadow memory 816 instead of directly writing to the controller 820 of the hardware component 818. In one implementation, the shadow memory 816 may be managed by the transactional memory system 810.

At step 834, components of the device may repeatedly service several ioctl( ) function calls by repeating steps 830 and 832 for each ioctl( ) call. In certain embodiments, the memory operations performed by the invocation of the icoctl ( )[ioctl( )??] call may be performed and buffered in the shadow memory 816. At 836, the transaction managed by the transactional memory system 810 may be completed and all changes from the transaction may be reflected in the shadow memory 816. At step 838, components of the device may push the changes from the shadow memory 816 to the controller 820 of the hardware component 818.

As shown in FIG. 8, using techniques described herein, several processes (e.g., 802, 804 and 806) may concurrently execute memory operations targeted to the same hardware component. However, in instances where different processes may have memory operations targeting the same memory addresses (or regions) mapped to the hardware component, the process that commences execution first may still block subsequent processes from accessing the hardware component. In such instance, once the write operations to the hardware controller 820 are completed, the processes targeting the same memory address (or regions) may be unblocked (step 840).

Above figures, such as FIG. 5, FIG. 6 and FIG. 8, provide example configurations of a device that uses transactional memory for allowing multiple processes to make forward progress and continue execution of instructions. The configurations shown in these figures are non-limiting and various other configurations may be used without departing from the scope of the invention. For example, in FIG. 8, although the transactional memory system 810, the TB DB 812, the module 808, and the hardware shadow memory 816 are shown as separate components, in certain embodiments, all or a few of the above mentioned components may be implemented as part of the transactional memory system 810.

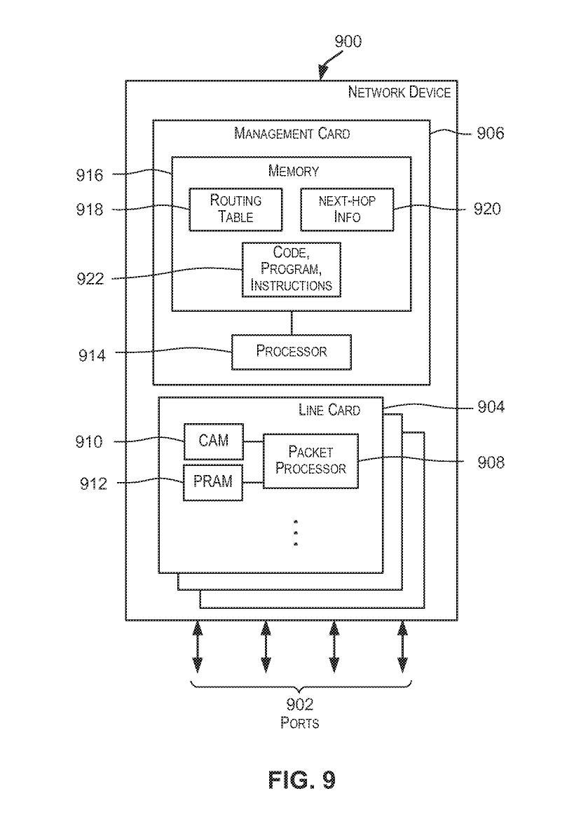

FIG. 9 depicts a simplified block diagram of a network device 900 that may be configured to perform embodiments of the present invention. The network device 900 illustrates only one management card and line card for illustration purposes, but may be extended to provide multiple management cards and line cards. Network device 900 may be a router or switch that is configured to forward data such as a router or switch provided by Brocade Communications Systems, Inc. In the embodiment depicted in FIG. 9, network device 900 comprises a plurality of ports 902 for receiving and forwarding data packets and multiple cards that are configured to perform processing to facilitate forwarding of the data packets. The multiple cards may include one or more line cards 904 and one or more management cards 906. A card, sometimes also referred to as a blade or module, can be inserted into the chassis of network device 900. This modular design allows for flexible configurations with different combinations of cards in the various slots of the device according to differing network topologies and switching requirements. The components of network device 900 depicted in FIG. 9 are meant for illustrative purposes only and are not intended to limit the scope of the invention in any manner. Alternative embodiments may have more or fewer components than those shown in FIG. 9.

Ports 902 represent the I/O plane for network device 900. Network device 900 is configured to receive and forward data using ports 902. A port within ports 902 may be classified as an input port or an output port depending upon whether network device 900 receives or transmits a data packet using the port. A port over which a data packet is received by network device 900 is referred to as an input port. A port used for communicating or forwarding a data packet from network device 900 is referred to as an output port. A particular port may function both as an input port and an output port. A port may be connected by a link or interface to a neighboring network device or network. Ports 902 may be capable of receiving and/or transmitting different types of data traffic at different speeds including 1 Gigabit/sec, 10 Gigabits/sec, or more. In some embodiments, multiple ports of network device 800 may be logically grouped into one or more trunks.

Upon receiving a data packet via an input port, network device 900 is configured to determine an output port for the packet for transmitting the data packet from the network device to another neighboring network device or network. Within network device 900, the packet is forwarded from the input network device to the determined output port and transmitted from network device 900 using the output port. In one embodiment, forwarding of packets from an input port to an output port is performed by one or more line cards 904. Line cards 904 represent the data forwarding plane of network device 900. Each line card 904 may comprise one or more packet processing entities 908 that are programmed to perform forwarding of data packets from an input port to an output port. A packet processing entity on a line card may also be referred to as a line processing entity. Each packet processing entity 908 may have associated memories to facilitate the packet forwarding process. In one embodiment, as depicted in FIG. 9, each packet processing entity 908 may have an associated content addressable memory (CAM) 910 and a RAM 912 for storing forwarding parameters (RAM 912 may accordingly also be referred to as a parameter RAM or PRAM). In one embodiment, for a packet received via an input port, the packet is provided to a packet processing entity 908 of a line card 904 coupled to the input port. The packet processing entity receiving the packet is configured to determine an output port of network device 900 to which the packet is to be forwarded based upon information extracted from the packet. The extracted information may include, for example, the header of the received packet. In one embodiment, a packet processing entity 908 is configured to perform a lookup in its associated CAM 910, using the extracted information. A matching CAM entry then provides a pointer to a location in the associated PRAM 912 that stores information identifying how the packet is to be forwarded within network device 900. Packet processing entity 908 then facilitates forwarding of the packet from the input port to the determined output port.

Since processing performed by a packet processing entity 908 needs to be performed at a high packet rate in a deterministic manner, packet processing entity 908 is generally a dedicated hardware device configured to perform the processing. In one embodiment, packet processing entity 908 is a programmable logic device such as a field programmable gate array (FPGA). Packet processing entity 908 may also be an ASIC.

Management card 906 is configured to perform management and control functions for network device 900 and thus represents the management plane for network device 900. In one embodiment, management card 906 is communicatively coupled to line cards 904 and includes software and hardware for controlling various operations performed by the line cards. In one embodiment, a single management card 906 may be used for all the line cards 904 in network device 900. In alternative embodiments, more than one management card may be used, with each management card controlling one or more line cards.

A management card 906 may comprise a processing entity 914 (also referred to as a management processing entity) that is configured to perform functions performed by management card 906 and associated memory 916. As depicted in FIG. 9, the routing table 918 and associated next-hop and RI information 920 may be stored in memory 916. The next-hop and RI information may be stored and used in an optimized manner as described above. Memory 916 is also configured to store various programs/code/instructions 922 and data constructs that are used for processing performed by processing entity 914 of management card 906. For example, programs/code/instructions, which, when executed by processing entity 914, cause the next-hop information to be stored in an optimized manner, may be stored in memory 916. In one embodiment, processing entity 914 is a general purpose microprocessor such as a PowerPC, Intel, AMD, or ARM microprocessor, operating under the control of software 922 stored in associated memory 916. In yet other embodiments, virtual machines running on microprocessors may act as one or more execution environments running on the network device.

In one embodiment, the functions performed by management card processing entity 914 include maintaining a routing table, creating associations between routes in the routing table and next-hop information, updating the routing table and associated next-hop information responsive to changes in the network environment, and other functions. In one embodiment, management processing entity 914 is configured to program the packet processing entities and associated memories of line cards 904 based upon the routing table and associated next-hop information. Programming the packet processing entities and their associated memories enables the packet processing entities to perform data packet forwarding in hardware. As part of the programming of a line card packet processing entity and its associated memories, management processing entity 914 is configured to download routes and associated next-hops information to the line card and program the packet processing entity and associated memories. Updates to the next-hop information are also downloaded to the line cards to enable the packet processing entities on the line cards to forward packets using the updated information.

What is claimed is:

1. A device comprising:
a memory;
one or more processing entities configurable to execute a first transaction comprising one or more write operations to a first memory address, and a second transaction comprising one or more write operations to a second memory address, wherein the first memory address and the second memory address are mapped to a controller for a hardware component and wherein the one or more processing entities commence execution of the second transaction after the first transaction starts execution and before the completion of the first transaction; and
a transactional memory system configurable to:
communicate data written to the first memory address from the first transaction to the controller upon completion of the first transaction; and
communicate data written to the second memory address from the second transaction to the controller upon completion of the second transaction.

2. The device of claim 1, wherein the execution of the one or more write operations to the first memory address from the first transaction does not block the execution of the one or more write operations to the second memory address from the second transaction and vice versa.

3. The device of claim 1, wherein:
the one or more processing entities are further configurable to commence execution of a third transaction after the first transaction starts execution and before the completion of the first transaction, the third transaction comprising one or more write operations targeted to the first memory address; and
the transactional memory system further configurable to block the execution of the third transaction until the completion of the first transaction and the update of the first memory location upon completion of the first transaction.

4. The device of claim 1, wherein the first transaction executes from a first process and the second transaction executes from a second process.

5. The device of claim 1, wherein a portion of memory is in a first state prior to commencing execution of operations from the first transaction by the one or more processing entities and wherein, in response to a failure event, the one or more processing entities are further configurable to stop execution of the first transaction after execution of a subset of operations from the plurality of operations; and the transactional memory system is further configurable to cause the state of the portion of memory to be in the first state.

6. The device of claim 5, wherein causing the state of the portion of memory to be in the first state prior to commencement of the execution of the transaction by the second processing entity comprises:
tracking changes to the portion of the memory by the first processing entity during the executing of the transaction on the first processing entity; and
reverting the changes back to the first state prior to commencement of the execution of the transaction by the second processing entity.

7. The device of claim 5, wherein causing the state of the portion of memory to be in the first state prior to commencement of the execution of the transaction by the second processing entity comprises:
buffering changes directed to the portion of the memory during executing of the transaction in a memory buffer; and
discarding the buffered changes in the memory buffer.

8. The device of claim 1, wherein the device is a network device.

9. A method comprising:
executing, by one or more processing entities, a first transaction comprising one or more write operations to a first memory address;
executing, by the one or more processing entities, a second transaction comprising one or more write operations to a second memory address, wherein the one or more processing entities commence execution of the second transaction after the first transaction starts execution and before the completion of the first transaction;
communicating data written to the first memory address from the first transaction to a controller upon completion of the first transaction; and
communicating data written to the second memory address from the second transaction to the controller upon completion of the second transaction.

10. The method of claim 9, wherein the execution of the one or more write operations to the first memory address from the first transaction does not block the execution of the one or more write operations to the second memory address from the second transaction and vice versa.

11. The method of claim 9, further comprising:
executing a third transaction, by the one or more processing entities, after execution and before the completion of the first transaction, the third transaction comprising one or more write operations targeted to the first memory address; and
blocking the execution of the third transaction until the completion of the first transaction and the updating of the first memory location upon completion of the first transaction.

12. The method of claim 9, wherein the first transaction executes from a first process and the second transaction executes from a second process.

13. The method of claim 9, further comprising:
stopping execution of the first transaction, by the one or more processing entities, in response to a failure event; and
causing the state of a portion of memory to be in a first state, wherein the portion of memory is in the first state prior to commencing execution of the first transaction.

14. The method of claim 13, wherein causing the state of the portion of memory to be in the first state prior to commencement of the execution of the transaction by the second processing entity comprises:
tracking changes to the portion of the memory by the first processing entity during the executing of the transaction on the first processing entity; and
reverting the changes back to the first state prior to commencement of the execution of the transaction by the second processing entity.

15. The method of claim 13, wherein causing the state of the portion of memory to be in the first state prior to commencement of the execution of the transaction by the second processing entity comprises:
buffering changes directed to the portion of the memory during executing of the transaction in a memory buffer; and
discarding the buffered changes in the memory buffer.

16. The method of claim 9, wherein the device is a network device.

17. A non-transitory computer-readable storage medium, wherein the non-transitory computer-readable storage medium comprises instructions executable by one or more processing entities, the instructions comprising instructions to:
execute a first transaction comprising one or more write operations to a first memory address;
execute a second transaction comprising one or more write operations to a second memory address, wherein the one or more processing entities commence execution of the second transaction after the first transaction starts execution and before the completion of the first transaction;
communicate data written to the first memory address from the first transaction to a controller upon completion of the first transaction; and
communicate data written to the second memory address from the second transaction to the controller upon completion of the second transaction.

18. The non-transitory computer-readable storage medium of claim 17, wherein the execution of the one or more write operations to the first memory address from the first transaction does not block the execution of the one or more write operations to the second memory address from the second transaction and vice versa.

19. The non-transitory computer-readable storage medium of claim 17, further comprising instructions to:
execute a third transaction after execution and before the completion of the first transaction, the third transaction comprising one or more write operations targeted to the first memory address; and
block the execution of the third transaction until the completion of the first transaction and the updating of the first memory location upon completion of the first transaction.

20. The non-transitory computer-readable storage medium of claim 17, further comprising:
stopping execution of the first transaction, by the one or more processing entities, in response to a failure event; and
causing the state of a portion of memory to be in a first state, wherein the portion of memory is in the first state prior to commencing execution of the first transaction.
